(19) United States
(12) Patent Application Publication
(10) Pub. No.: US 2002/0152667 A1
(43) Pub. Date: Oct. 24, 2002

(54) Rotating spring wheel for leveling epoxy coated fishing flies and lures

(76) Inventor: Damian Coccio, Pottstown, PA (US)

Correspondence Address: Damian Coccio, 2139 Yarnall Road, Pottstown, PA, 19464, US

(21) Appl. No.: 09/837,318

(22) Filed: Apr. 19, 2001

(51) Int. Cl. A01K 1/00

(52) U.S. Cl. 43/4

(57) ABSTRACT

The use of epoxies, adhesives and coatings to produce fishing fly bodies and other fishing lures is an increasingly popular practice in fishing fly tying and lure making. The most critical and final step of this process is rotating the fishing fly or lure while the epoxy is curing thereby leveling the coating of the epoxy around the body. My invention is a simple wheel assembly with a spring wrapped around the circumference which is used to secure groups of individual fishing flies and lures before, during and after an epoxy or other finish is applied to them. The assembly holds the fishing flies and lures securely while they are rotating allowing the epoxy or other finish to level about the axis of the fishing flies and lure hooks. My invention allows the user to attach and remove the fishing flies and lures easily and to manipulate the position of the wheel by simply moving it with their hands. Current attempts at systems of this type have major shortcomings because they have used circular foam and cork type materials in which the point of the fly or lure hook is inserted. Instability of the fly and wear on the wheel are just some of the major limitations of current devices which make my invention extremely desirable amongst fly tiers and lure makers.

### BACKGROUND OF THE INVENTION

1. Field of Invention

The use of epoxies, adhesives and coatings to produce fishing fly bodies and other fishing lures is an increasingly popular practice in fishing fly tying and lure making. The most critical and final step of this process is rotating the fishing fly or lure while the epoxy is curing thereby leveling the coating of the epoxy around the body.

This invention relates to device which is used to secure and impart rotational motion on epoxy coated fishing flies and lures to provide a leveling effect of the adhesives and coatings such as, but not limited to epoxy, around the entire body while the epoxy is curing thereby giving the Fly or Lure relative axial symmetry and a generally more attractive and realistic fish-like appearance. More specifically, this invention is an inexpensive, simple mechanical system utilizing a spring that provides a unique method of holding the individual flies and lures on a wheel by their hooks, which will withstand repeated attachment and removal of flies and lures. The device's unique design allows the user to manipulate the position of the wheel independent of its drive shaft and thereby add, remove or gain access to individual flies and lures as needed during the lure making process.

1. Description of Prior Art

Devices for leveling epoxy coated fishing flies and lures that have been or are currently available employ foam or cork disc systems for holding the flies and lures. These systems have major shortcomings such as: loosening of the flies as they are sitting on the rotary wheel causing the fly to alter its position or fall off ruining the uncured epoxy coating; hook barbs getting stuck in the foam or cork; excessive pressure to insert the hook point into the foam or cork is required along the device's horizontal plane which causes the device to slide; wear on the cork or foam caused from repeated insertion and removal causes perforations which significantly diminish it's ability to hold the flies and lures securely. Other shortcomings of devices currently available may include inability to easily, reliably manipulate the position of the cork or foam disc and poor access to apply coatings to the fly or lure.

My invention utilizes a spring and several other inexpensive mechanical components to solve all of the aforementioned problems and shortcomings with the currently available systems, thereby providing a more stable, reliable and long lasting wheel for rotating and leveling epoxy coated fishing flies and lures.

### BRIEF SUMMARY OF THE INVENTION

My invention is a simple rotary disc assembly with a spring wrapped around the perimeter or circumference which is used to secure groups of individual fishing flies and lures before, during and after an epoxy or other finish is applied to them. The assembly holds the fishing flies and lures securely while they are rotating allowing the epoxy or other finish to level about the axis of the fishing flies and lure hooks.

My invention allows the user to attach and remove the fishing flies and lures easily and to manipulate the position of the wheel by simply moving it with their hands. My invention's design causes no damage or wear to the drive motor, since the spring wheel's design has a slip clutch which limits the drive shaft torque.

### OBJECTS AND ADVANTAGES

Accordingly, several objects and advantages of the present invention are:

A) to employ a simple assembly using uniquely arranged inexpensive mechanical components that can be used to secure and rotate fishing flies and lures before, during and after adhesives or other coating are applied to them and survive repeated insertion and removal of the flies or lures.

B) to employ a wheel system of a diameter and thickness that would allow sufficient working space on it's circumference and improved accessibility between flies and lures and the wheel.

C) to employ a shaft which passes through the axis of the wheel discs to support, rotate and keep the disc's in proper axial alignment.

D) to employ a slightly stretched coil extension spring wrapped about the wheel's circumference for holding the hooks of the fishing flies and lures which will maintain its ability to secure the fishing flies and lures through rotation and repeated attachment and removal. The spring is stretched slightly so that the individual coils of the spring are slightly open and can accept the fishing fly or lure's hooks easily.

E) to employ a simple, controlled friction slip clutch that would allow the user to manipulate the wheel position independent of the motor shaft position to gain access to, add, or remove the fishing flies and lures. The slip clutch is designed to provide a consistent amount of friction and to also control the torque stress on the drive motor's shaft.

F) to employ a dual disc system where the disc's are angularly formed, molded or beveled about their circumference to transfer some of the inward force of the wrapped extension spring in an outward direction along the shaft passing through the disc's axis. This force transferred outward along the disc's axis produces a force sufficient enough to produce controlled friction in the slip clutch arrangement.

### BRIEF DESCRIPTION OF SEVERAL VIEWS OF THE DRAWING

FIG. 1. shows the exploded view of the unassembled spring wheel assembly

FIG. 2. shows the side view of the completed spring wheel assembly

FIG. 3. shows the front view of the completed spring wheel assembly with flies inserted

FIG. 4. shows the rear view of the completed spring wheel assembly

FIG. 5 shows the side view of the completed spring wheel assembly utilizing a single solid disc with a cut about the circumference

### DETAILED DESCRIPTION OF THE INVENTION

My invention is a rotary spring wheel for securely holding fishing flies and lures before during and after applying a coating, finish or adhesive such as, but not limited to epoxy. The spring wheel is typically coupled to a motor or other rotational device that provides the leveling effect required to make epoxy coated fishing flies and Lures.

My invention for leveling epoxy coated fishing flies and lures is different from all other devices of this type. I have employed inexpensive mechanical components to address all of the shortcomings of present inventions of this type. Due to my device's unique simplicity it can be easily manufactured with inexpensive machine tools and assembled quickly or can be injection molded at higher volumes.

My invention is assembled with nine inexpensive mechanical components: A shaft screw, bushing, shaft coupler, two angular formed or beveled discs, a friction washer and an extension spring. These components are combined in a unique way to provide an extremely functional rotary wheel, which can secure multiple groups of fishing flies and lures and be attached to a drive shaft of a motor or other rotational device.

My invention is a simple rotary disc assembly with a spring wrapped around it's perimeter or circumference in which one end is fastened to the other end by a hook, loop, inter-threading or by other means. To provide adequate gap and holding force for the fishing flies and lures, the coil spring is stretched slightly and placed about the circumference of a wheel much like a tire is placed on a rim.

My device is unique in its use of a coil spring to serve as a mechanism for holding the individual flies or lures. My device is also unique in the preferred embodiment where the coil spring has a dual purpose of holding the flies and lures and also to provide the inward radial force required to maintain consistent torque in the slip clutch arrangement.

My device's slightly stretched coil spring allows one to wedge objects between the coils of the spring and hold them very securely. The adjacent coils tend to separate around the object and place a significant amount of force on the object, thereby holding it securely in place like a vise. When the object is removed, the coil spring will return to its previous geometry with no signs of wear. My device's coils spring is a perfect choice for securing and leveling epoxy coated fishing flies and lures, since typically there will be many repetitions of inserting and removing the individual flies and lures as new ones are made and coated.

My invention can accept a wide range of object sizes and shapes between the spring coils, and the range of sizes can be adjusted by changing the amount of tension on the coil spring or by changing the coil spring characteristics. The amount of tension on the coil spring can be easily changed by either varying the length of the spring or by changing the wheel diameters.

In the preferred embodiments the wheel may range from 1 inch to 25 inches in diameter and from 0.1 inches to 6 inches in thickness. The coil extension spring may range from 0.1 inches to 2 inches in diameter and from 1 inch to 100 inches long.

My invention may have other embodiments such as a solid, one-piece disc assembly molded, formed, milled or cut to accept the spring, or it may use a soft material such as foam or cork to holds the spring in place by compression of the soft material. My invention may be simplified for some limited torque applications and assembled without the drag washers or bushing. The shape of my device need not be circular and may be semicircular or of a polygon shape. The spring may also be stretched in a linear configuration and be used to rotate the fishing flies and lures.

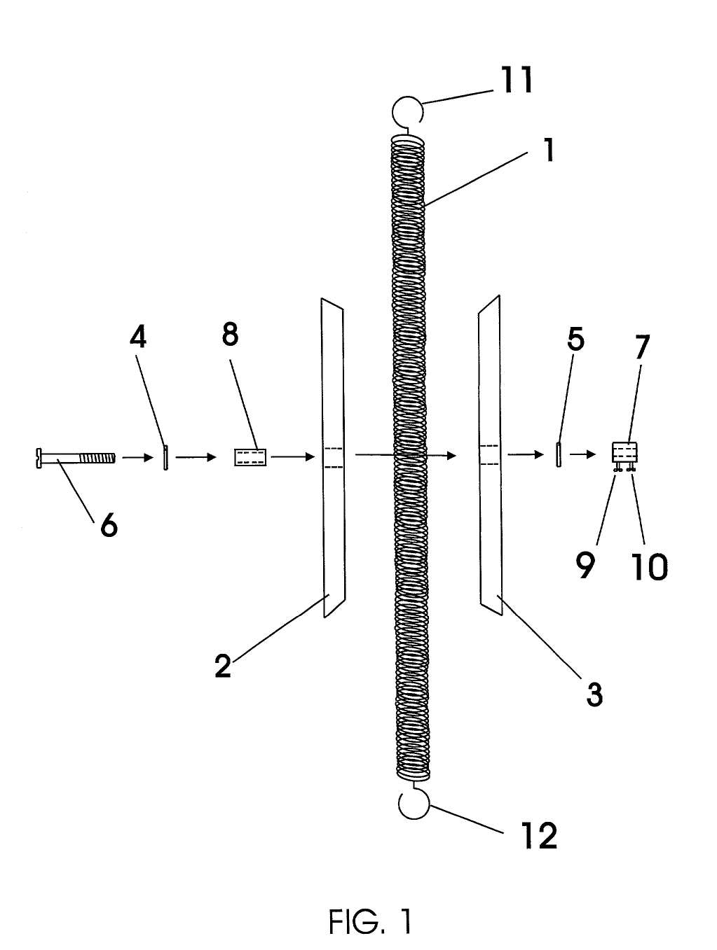

### DESCRIPTION—FIG. 1

An exploded side view of a typical embodiment of the spring wheel assembly is illustrated in FIG. 1. The shaft bushing (8) is inserted into the front angular formed or beveled disc (2) until it protrudes past the front angular formed or beveled disc (2). The protruding shaft bushing is inserted into the rear angular formed or beveled disc (3) until the front angular formed or beveled disc (2) is in contact with the rear angular formed or beveled disc (3). The shaft screw (6) is inserted through the front friction washer (4), through the bushing (8) and through the front and rear angular formed discs. The protruding shaft screw (6) is inserted into the rear friction washer (5) and threaded into the drive shaft coupler (7) until the assembly is slightly tight. The drive shaft coupler's front set-screw (9) is tightened on the shaft screw thereby locking its position. The drive shaft coupler's rear set screw (10) is tightened onto a drive shaft of arbitrary size. The coil extension spring's (1) top end (11) is connected to the coil extension spring bottom end (12) by inter-hooking or by threading the ends together. The completed spring loop is fitted over the completed assembly of the shaft screw (6), friction washer and (4), shaft bushing (8), front angular formed or beveled disc (2), rear angular formed or beveled disc (3), rear friction washer (5), and drive shaft coupler (7).

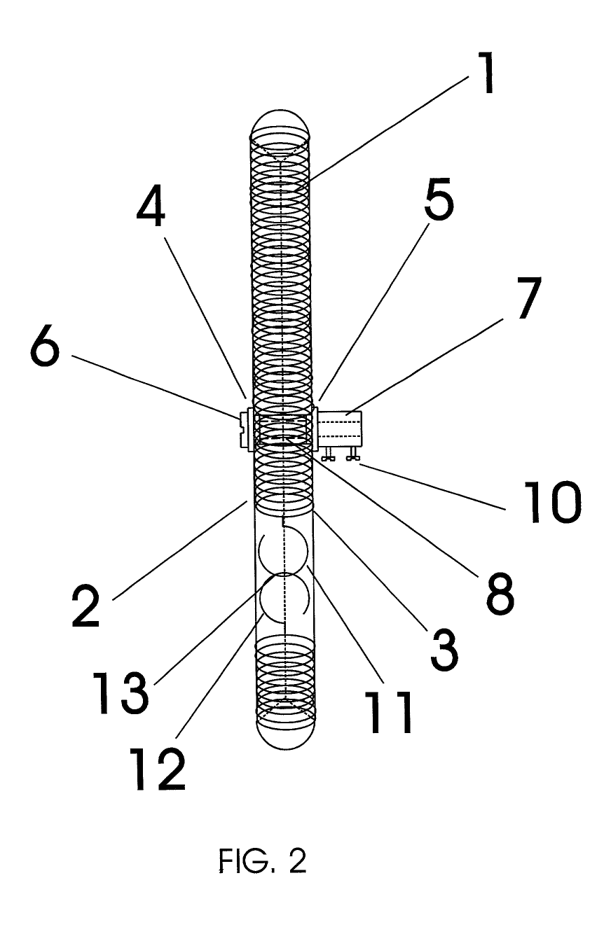

### DESCRIPTION—FIG. 2

A side view of a typical embodiment of the assembled components of the spring wheel assembly is illustrated in FIG. 2.

The coil extension spring (1) is wrapped about the circumference of the combination of the front angular formed or beveled disc (2) and the rear angular formed or beveled disc (3). The extension spring's top loop (11) is securely locked with it's bottom loop (12) at the fastening section (13). Due to the beveled edges of the front discs (2) and the rear disc (3) the inward radial force of the stretched coil extension spring (1) produces an outward force along the shaft screw (6), which creates pressure on the front friction washer (4) and the head of the shaft screw (6) and also between the rear friction washer (5) and the front side of the shaft coupler (7). The outward force of the front disc (2) and rear disc (3) against the head of the shaft screw (6) and the shaft coupler (7) produces a controlled amount of friction if the wheel is stopped or if it's position is manipulated.

The shaft coupler (7) provides the ability to connect to a drive motor or other rotary motion producing device's shaft, which can then be locked securely into place using the shaft coupler's rear set screw (10). The rotary force imparted by the drive motor or other rotary motion producing device's shaft is limited at the junction of the front friction washer (4) and the front angular formed or beveled disc (2) as well at the rear friction washer (5) and the rear angular formed or beveled disc (3). The amount of friction between the front angular formed or beveled disc (2) and the friction washer (4) may be changed by tightening or loosening the shaft screw (6). The amount of friction between the rear angular formed or beveled disc (1) and the friction washer (5) may be changed by tightening or loosening the shaft screw (6).

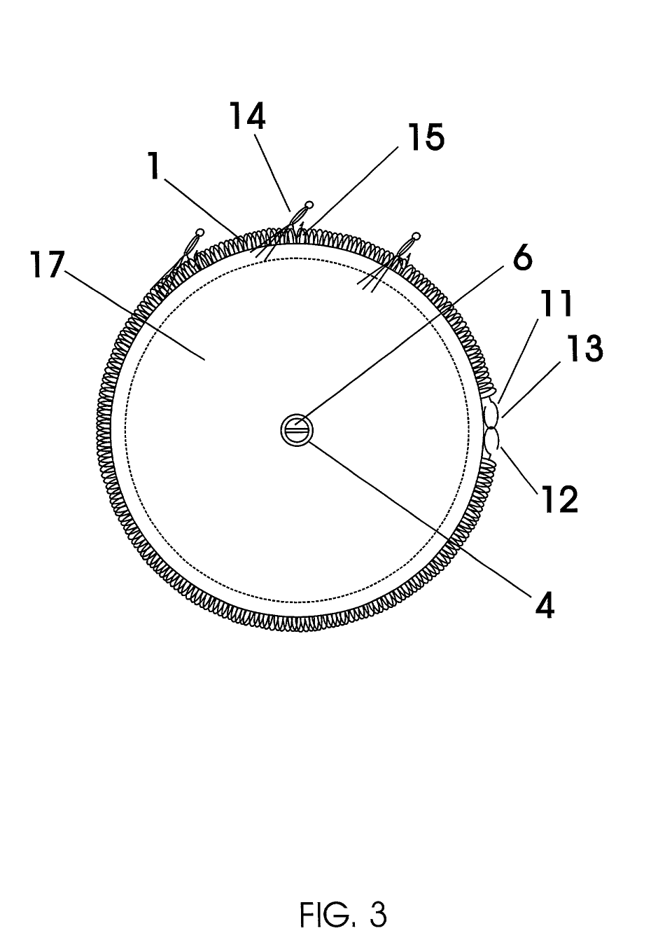

### DESCRIPTION—FIG. 3

A front view of a typical embodiment of the assembled components of the spring wheel assembly with insertion of multiple fishing flies or lure hooks is illustrated in FIG. 3. The coil extension spring (1) is wrapped about the front and rear angular formed or beveled discs (17), stretched with sufficient tension to allow small spaces in the coils and fastened by hook (11,12), loop, or by threading to its opposite end at the fastening section (13). When the fly or lure hook (14) is inserted between the coils of the stretched coil extension spring (1) a slight separation of the spring occurs (15) as well as sufficient force to hold the hook. The entire assembly is rotated about the axis of the shaft screw (6) and produces a leveling effect on the epoxy coated fishing fly or lure (14). The amount of friction between the front angular formed or beveled disc (17) and the friction washer (4) may be changed by tightening or loosening the shaft screw (6).

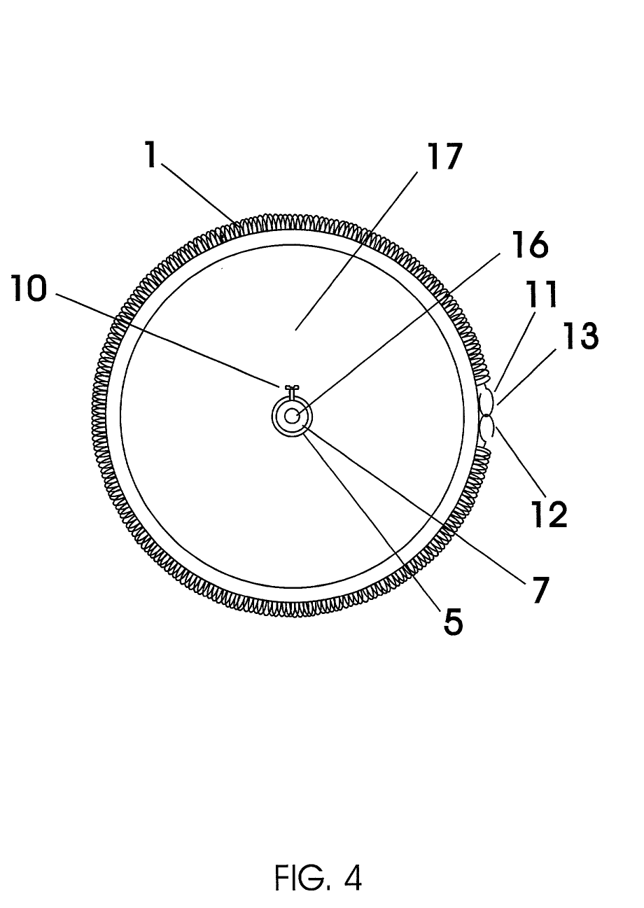

### DESCRIPTION—FIG. 4

A rear view of a typical embodiment of the assembled components of the spring wheel assembly is illustrated in FIG. 4.

The coil extension spring (1) is wrapped about the front and rear angular formed or beveled discs (17), stretched with sufficient tension to allow small spaces in the and fastened by hook (11,12), loop, or by threading to its opposite end at the fastening section (13).

The shaft coupler (7) has an arbitrary size hole (16) which gives the ability to connect the wheel assembly to a drive motor or other rotary motion producing device's shaft, which can then be locked securely into place using the shaft coupler's rear set screw (10). The rotary force or torque imparted by the drive motor or other rotary motion producing device's shaft is limited at the junction of the friction washer (5) and the angular formed or beveled discs (17). The amount of friction between the angular formed or beveled discs (17) and the friction washer (5) may be changed by tightening or loosening the shaft screw.

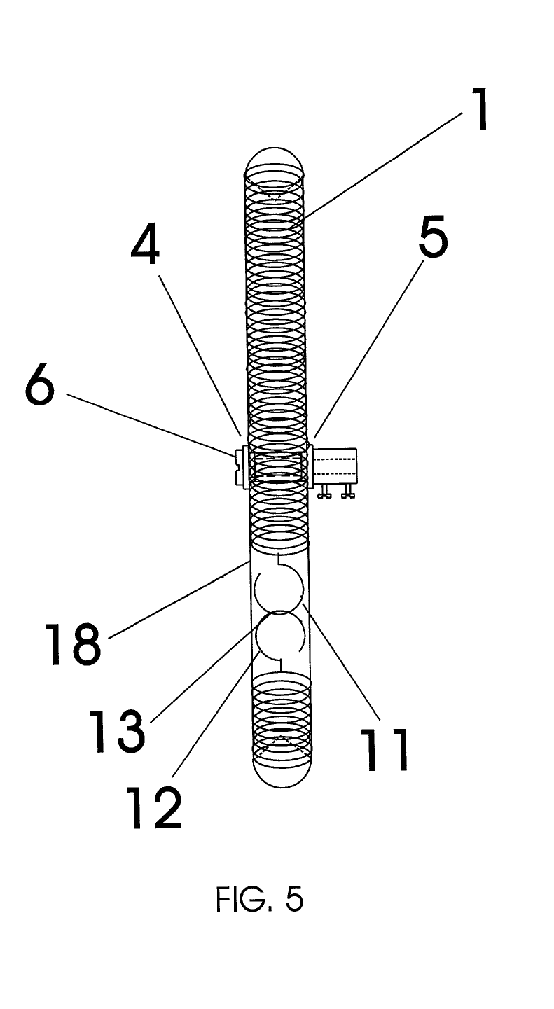

### DESCRIPTION—FIG. 5

A side view of another typical embodiment of the spring wheel assembly utilizing a single solid disc instead of two separate discs is illustrated in FIG. 5.

The coil extension spring (1) is wrapped about the single solid disc (18), stretched with sufficient tension to allow small spaces in the spring and fastened by hook (11,12), loop, or by threading to its opposite end at the fastening section (13). The single solid disc (18) may be made of plastic, wood, metal, foam, or other materials. Due to the shape of the solid disc (18) a V, U or other shaped cut around the discs circumference will allow the spring to sit securely in the cut like a tire fits on a rim. In the case where foam or other compressible material is used for the single solid disc (18), the extension spring (1) may be used to compress the material forming a rim for the spring without the need for the circumference cut. The rotary force imparted by the drive motor or other rotary motion producing device's shaft can be torque limited at the junction of the friction washers (4,5) and the single solid disc (18). The amount of friction between the single solid disc (18) and the friction washers (4,5) may be changed by tightening or loosening the shaft screw.

I claim:

1. A device for holding fishing flies and lures comprising:
a coil spring wherein the forces present in between each pair of adjacent windings are used for holding fishing lure or fly hooks or bodies.
a wheel wherein said coil spring is wrapped about the perimeter or circumference of the wheel and used for holding fishing lure hooks, fly hooks or fly or lure bodies.

2. The device of claim 1 wherein said coil spring is an extension type coil spring wherein the opposite ends are fastened to each other by hook, loop or by other means, forming a circular loop of coil spring which is wrapped about said wheel.

3. The device of claim 2 wherein said wheel ranges from 1 inch to 25 inches in diameter and ranges from 0.1 inches to 6 inches in thickness and said coil spring ranges from 0.1 inches to 2 inches in diameter and ranges from 1 inch to 100 inches long.

4. The device of claim 3 wherein said wheel is circular, semi-circular, or a polygon, cut or molded to hold said coil extension spring; or is fabricated from a soft material such as, but not limited to foam, or cork which holds said coil extension spring by compressing the material.

5. The device of claim 4 wherein said wheel is part of a slip clutch or torque limiter.

6. The device of claim 5 wherein said wheel is connected to a motor or other rotational motion producing device.

7. The device of claim 6 wherein said additional wheels of the same or of varied sizes are added to an axel to increase the device's holding capacity.

8. The device of claim 7 wherein said wheel and said spring are used to secure and rotate bodies other than fishing flies or lures.

9. The device of claim 3 wherein said wheel has a molded motor coupler as part of said wheel or where coupler is attached directly to said wheel without a shaft screw.

10. The device of claim 9 wherein said additional wheels of the same or of varied sizes are added to increase the device's holding capacity.

11. The device of claim 10 wherein said wheel and said spring are used to secure and rotate bodies other than fishing flies or lures.

12. The device of claim 3 wherein said wheel is formed by two or more circular, semi-circular, or polygon like discs or plates with angularly formed or beveled edges about their circumference or perimeter used to hold said spring.

13. The device of claim 12 wherein said wheel is connected to a slip clutch or torque limiter.

14. The device of claim 13 wherein said wheel has a shaft screw or axel passing through it.

15. The device of claim 14 wherein said extension coil spring produces a inward radial force which due to the said angular shape of said discs edges will produce an outward force of said discs along the axis of said shaft screw or axel.

16. The device of claim 15 wherein said slip clutch or torque limiter is formed by the friction due to said outward force of said discs along the axis of said shaft screw or axel against a shaft bushing, coupler or other surface.

17. The device of claim 16 wherein said shaft screw or axel passing through the axis of said wheel can be length adjusted to vary the amount of friction on said wheel.

18. The device of claim 17 wherein said wheel is coupled to a motor or other rotational motion producing device.

19. The device of claim 18 wherein said additional wheels of the same of varied sizes are added to an axel to increase the device's holding capacity.

20. The device of claim 19 wherein said wheel and said spring are used to secure and rotate bodies other than fishing flies or lures.
